(19) United States
(12) Patent Application Publication
(10) Pub. No.: US 2012/0191733 A1
(43) Pub. Date: Jul. 26, 2012

(54) COMPUTING DEVICE AND METHOD FOR IDENTIFYING COMPONENTS IN FIGURES

(75) Inventors: WEI-QING XIAO, Shenzhen City (CN); CHUNG-I LEE, Tu-Cheng (TW); CHIEN-FA YEH, Tu-Cheng (TW)

(73) Assignees: HON HAI PRECISION INDUSTRY CO., LTD., Tu-Cheng (TW); HONG FU JIN PRECISION INDUSTRY (ShenZhen) CO. LTD., Shenzhen City (CN)

(21) Appl. No.: 13/339,188

(22) Filed: Dec. 28, 2011

(30) Foreign Application Priority Data
Jan. 25, 2011 (CN) 201110026918.X

(51) Int. Cl. G06F 17/30

(52) U.S. Cl. 707/755; 707/E17.009; 707/E17.014

(57) ABSTRACT

A method for identifying components in figures extracts component numbers in a description section of a patent document that are coupled with a component name, and creates a component information list based on the component numbers. The method distinguishes each component number and respective positions of all the component numbers in a figure section of the patent document. The method detects a position of a cursor displayed on a display device when the figure section is being viewed. The method searches for a component name of a component number from the component information list when the cursor is positioned within a preset region around the component number, and displays the component name beside the component number in the figure section of the patent document on the display device.

### BACKGROUND

1. Technical Field

Embodiments of the present disclosure generally relate to image display technology, and more particularly to a computing device and a method for identifying components in figures.

2. Description of Related Art

In documents such as patents which include figures, components are labeled with numbers and not names. If a user wants to know a name of a component that is labeled only with a number in a patent document, the user has to read a description of the component in a purely textual section of the patent document, or in other documents to discover the name. The identification by name of components in patent figures is a waste of time and inconvenient for the user.

### BRIEF DESCRIPTION OF THE DRAWINGS

FIG. 1 is a block diagram of one embodiment of a computing device including a identification unit for identifying components in figures in a patent document.

FIG. 2 is a schematic diagram of one embodiment of a component information list.

FIG. 3 is a flowchart of one embodiment of a method for identifying components in figures.

FIG. 4 is a flowchart detailing step S12 in FIG. 3.

FIG. 5 is a flowchart detailing step S14 in FIG. 3.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

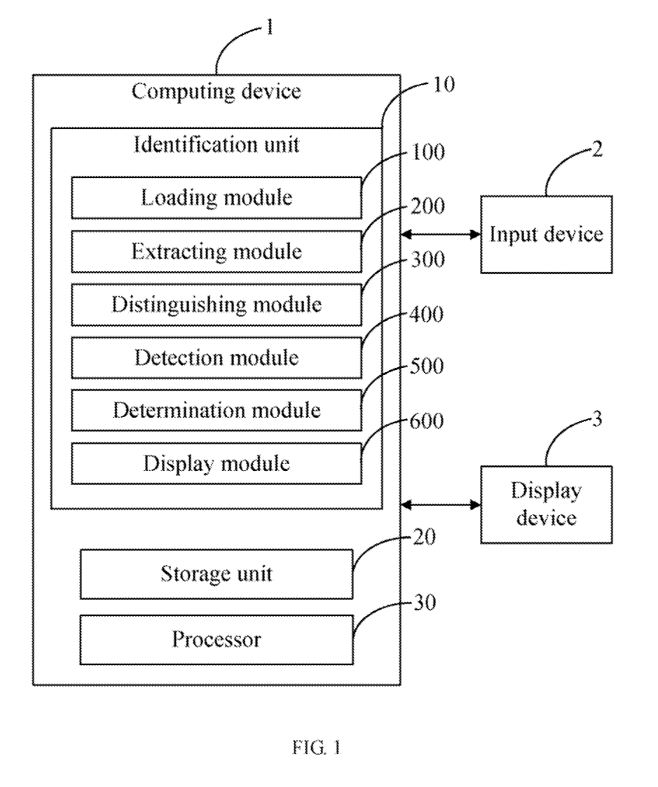

FIG. 1 is a block diagram of one embodiment of a computing device 1 including an identification unit 10 for identifying components in figures in a patent document. The computing device 1 further includes a storage unit 20 and a processor 30. The computing device 1 electrically connects to an input device 2 and a display device 3. In one embodiment, the input device 2 may be a mouse or a keyboard. The display device 3 displays patent documents that include patent figures. The input device 2 inputs data (such as cursor position data) to designate a component in the patent figures. Each patent figure consists of one or more components that are labeled numerically.

In the embodiment, when a patent figure is displayed on the display device 3, the identifying unit 10 displays the name of a designated component in response to a cursor of the input device 2 being positioned within a preset region around the numerical label of the component (hereinafter “component number”) in the patent figures.

In one embodiment, the identifying unit 10 may include one or more function modules (a description is given in FIG. 1). The one or more function modules may comprise computerized code in the form of one or more programs that are stored in the storage unit 20, and executed by the processor 30 to provide the functions of the identifying unit 10. The storage unit 20 may be a cache or a dedicated memory, such as an EPROM or a flash memory.

In one embodiment, the identifying unit 10 includes a loading module 100, an extracting module 200, a distinguishing module 300, a detection module 400, a determination module 500, and a display module 600.

The loading module 100 is operable to load one or more patent documents from the storage unit 20, and display the patent documents on the display device 3. The patent documents include a purely textual section (description section) and a figure section. The figure section includes one or more patent figures. In one embodiment, the patent document may be in WORD, PDF, JPG, or TIF format.

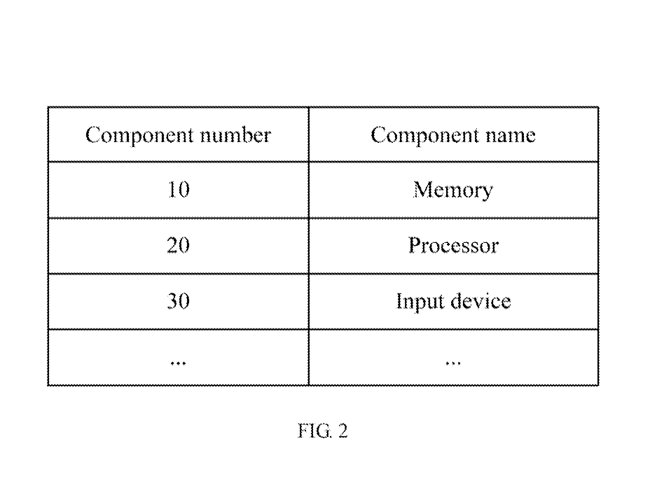

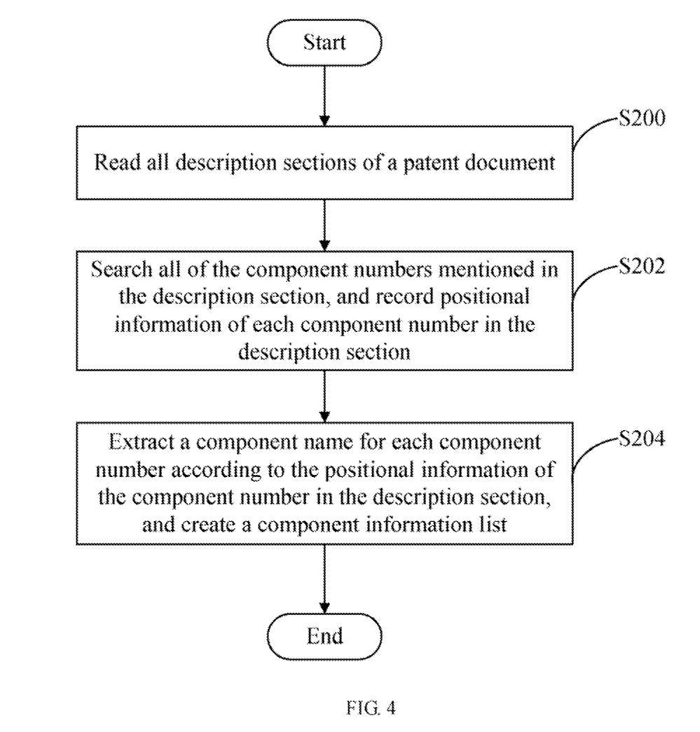

The extracting module 200 is operable to extract all component numbers coupled with a name of a component (hereinafter “component name”) from the description section of the patent document, and create a component information list (as shown in FIG. 2). A detailed procedure is given in FIG. 4.

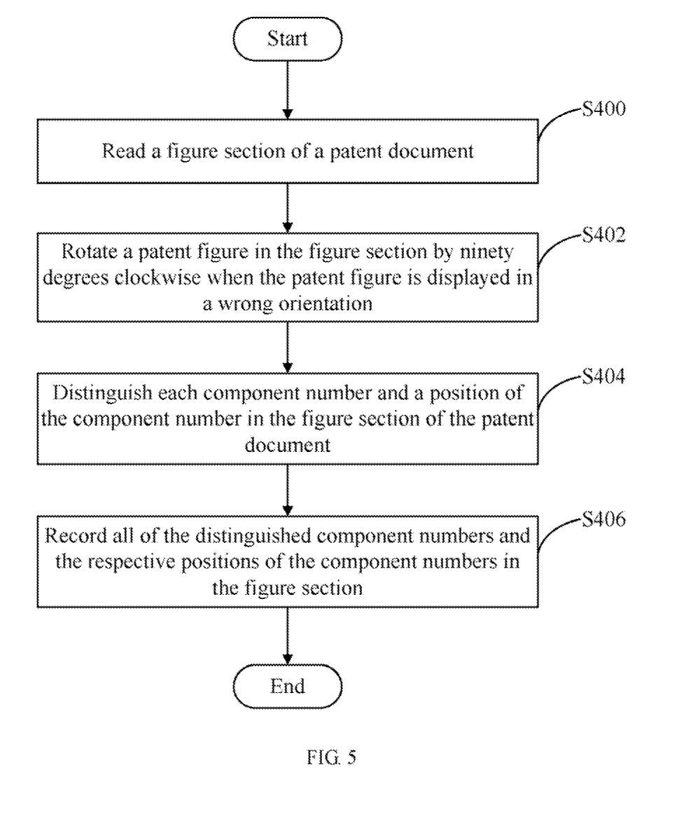

The distinguishing module 300 is operable to distinguish each component number in the figure section and respective positions of all the component numbers in the figure section. The respective positions are represented by coordinates of the component numbers in the figure section. A detailed procedure is given in FIG. 5.

The detection module 400 is operable to detect a position of the cursor displayed on the display device 3 when a user is viewing the figure section of the patent document, via operations of the input device 2.

The determination module 500 is operable to determine whether the position of the cursor is within a preset region around a component number. In one embodiment, the preset region around the component number is a rectangular area with a predetermined size, where the component number is in the middle of the rectangular area. The monitoring of the position of the cursor is constant.

The display module 600 is operable to search for the component name of a component number from the component information list when the cursor is positioned within the preset region around a component number, and display the component name beside the component number in the figure section of the patent document on the display device 3.

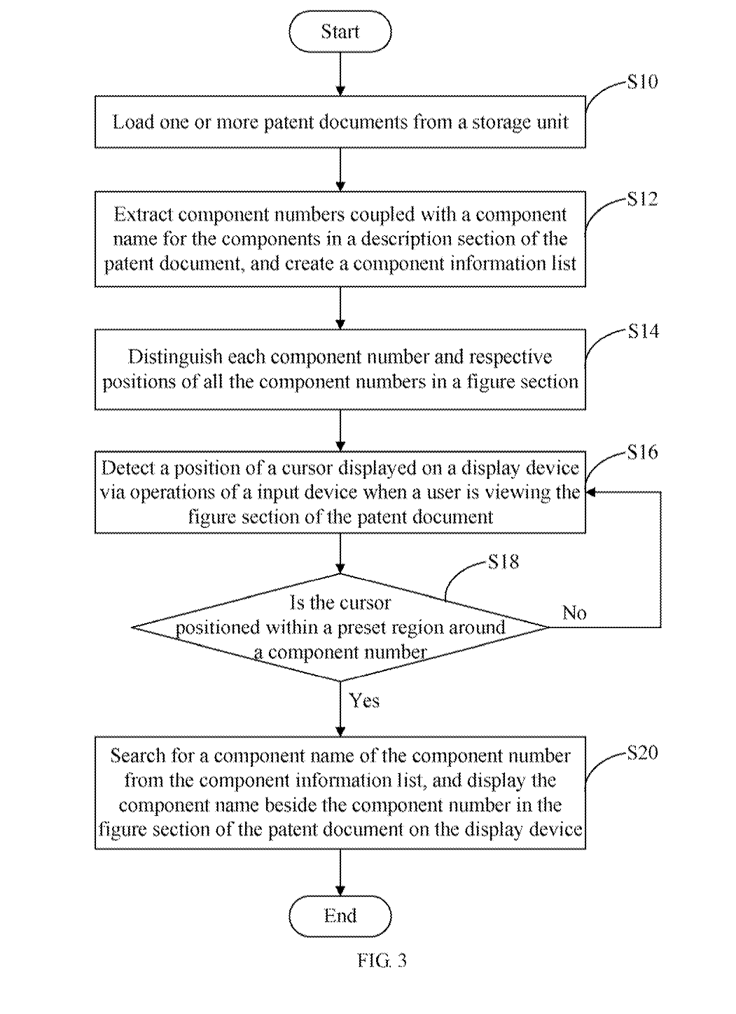

FIG. 3 is a flowchart of one embodiment of a method for identifying components in figures. Depending on the embodiment, additional steps may be added, others removed, and the ordering of the steps may be changed.

In step S10, the loading module 100 loads one or more patent documents from the storage unit 20, and displays the patent documents on the display device 3.

In step S12, the extracting module 200 extracts all the component numbers coupled with a component name for the components in the description section of the patent document, and creates a component information list (as shown in FIG. 2). A detailed procedure is given in FIG. 4.

In step S14, the distinguishing module 300 distinguishes each component number in the figure section and respective positions of all the component numbers in the figure section. The respective positions are represented by coordinates of the component numbers in the figure section. A detailed procedure is given in FIG. 5.

In step S16, the detection module 400 detects a position of the cursor displayed on the display device 3 via operations of the input device 2 when a user is viewing the figure section of the patent document.

In step S18, the determination module 500 determines whether the cursor is positioned within a preset region around a component number. In one embodiment, the preset region around the component number is a rectangular area with a predetermined size, where the component number is in the middle of the rectangular area. Until the cursor is positioned in the preset region around a component number, the procedure remains in step S16. If the cursor enters a preset region around a component number, step S20 is implemented.

In step S20, the display module 600 searches for the component name of the component number from the component information list, and displays the component name beside the component number in the figure section of the patent document on the display device 3.

FIG. 4 is a flowchart detailing step S12 in FIG. 3.

In step S200, the extracting module 200 reads all the description sections of the patent document.

In step S202, the extracting module 200 searches all of the component numbers mentioned in the description section, and records positional information (such as page number, column, line, and the numerical information) of each component number in the description section. The searching procedure includes:

(a1) The extracting module 200 reads and recognizes each sequential character in all of the description section of the patent document.

(a2) The extracting module 200 determines whether any character means “End of File (EOF)”. If a character meaning “EOF” is found, the searching procedure ends.

(a3) If a character does not mean “EOF”, the extracting module 200 determines whether the character is an effective number. In one embodiment, a number which: (1) begins with “0”; or (2) includes a “%”; or (3) is a decimal; or (4) has the characters “FIG.” or “FIGS” before it, is regarded as not being an effective number. If the character is not an effective number, the extracting module 200 continues to read the next sequential character in the description section.

(a4) If the character is an effective number, the extracting module 200 records the character, and any next-adjacent character also deemed to be an effective number, as a component number, and records the positional information of the component number in the description section, then reads the next character in the description section. For example, if the extracting module 200 reads the 16^{th} character in column one, line three on page two of the description section, and deems the 16^{th} character to be an effective number, and the extracting module 200 further reads the 17^{th} and 18^{th} characters as also being effective numbers, the extracting module 200 records the 16^{th}, 17^{th} and 18^{th} characters as a component number, and records “column one, line three, page two, 16.17.18” as the positional information of the component number.

In step S204, the extracting module 200 extracts a component name for each component number according to the positional information of the component number in the description section, and creates the component information list (as shown in FIG. 2). The extracting procedure includes:

(b1) The extracting module 200 reads each component number in the description section sequentially according to the positional information of the component numbers in the description section.

(b2) The extracting module 200 extracts one or more character strings consisting of a predetermined maximum quantity of characters immediately before the position of each component number in the description section. In one embodiment, the predetermined quantity is ten.

(b3) The extracting module 200 groups the extracted character strings by reference to the component numbers. For example, all of the extracted character strings in relation to the component number “10” are put into one group, and all of the extracted character strings in relation to the component number “20” are put into another group.

(b4) The extracting module 200 determines the same sub-character strings in each group as the component name in relation to the component number. For example, if the group of the component number “20” include the two character strings “a connector body” and “the connector body”, the two character strings have the same sub-character string “connector body”, thus “connector body” is regarded as the component name in relation to the component number “20”.

In one embodiment, if there is only one extracted character string in one group, the extracting module 200 searches for the first predetermined word forward from the position of the component number. and extracts characters between the first predetermined word and the component number, which is regarded as the component name in relation to the component number. In US patent documents, the predetermined word may be “a”, “an” or “the”. For example, if there is only one extracted character string “receive a friction reducing device, such as an O-ring” in the group of the component number “60”, the extracting module 200 searches for the first predetermined word “an” forward from the position of the component number “60”, and extracts the character “O-ring” between the first predetermined word “an” and the component number “60”, thus “O-ring” is regarded as the component name in relation to the component number “60”.

(b5) The extracting module 200 creates the component information list according to each component number and the component name in relation to the component number.

FIG. 5 is a flowchart detailing step S14 in FIG. 3.

In step S400, the distinguishing module 300 reads the figure section of the patent document.

In step S402, the distinguishing module 300 may rotate a patent figure in the figure section by ninety degrees clockwise when the patent figure is displayed in a wrong orientation. The wrong orientation of the patent figure may be defined as the patent figure being in landscape view instead of portrait view when the patent document is written because the width of the patent figure is greater than the height of the patent figure.

In step S404, the distinguishing module 300 distinguishes each component number and a position of the component number in the figure section of the patent document. In one embodiment, the distinguishing module 300 distinguishes each component number and the position of the component number using Optical Character Recognition (OCR) technology.

In step S406, the distinguishing module 300 records all of the distinguished component numbers and the respective positions of the component numbers in the figure section.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method being performed by a processor of a computing device, comprising:
(a) in a patent document comprising a description section and a figure section, extracting component numbers from the description section that are coupled with a component name, and creating a component information list based on the component numbers;
(b) distinguishing each component number and respective positions of all the component numbers in the figure section of the patent document;
(c) detecting a position of a cursor displayed in the figure section of the patent document on a display device; and
(d) searching for a component name of a component number from the component information list in response that the cursor is positioned within a preset region around the component number, and displaying the component name beside the component number in the figure section of the patent document on the display device.

2. The method as claimed in claim 1, wherein the step (a) comprises:
searching all of the component numbers mentioned in the description section, and recording positional information of each component number in the description section; and
extracting a component name for each component number according to the positional information of the component number in the description section, and creating the component information list.

3. The method as claimed in claim 1, wherein the step (b) comprises:
rotating a figure in the figure section by ninety degrees clockwise in response that the figure is displayed in a wrong orientation;
distinguishing each component number and a position of the component number in the figure section of the patent document; and
recording all of the distinguished component numbers and the respective positions of the component numbers in the figure section.

4. The method as claimed in claim 1, wherein the preset region around the component number is a rectangular area with a predetermined size, and the component number is in the middle of the rectangular area.

5. A non-transitory storage medium storing a set of instructions, the set of instructions capable of being executed by a processor to perform a method for identifying components in figures, the method comprising:
(a) in a patent document comprising a description section and a figure section, extracting component numbers from the description section that are coupled with a component name, and creating a component information list based on the component numbers;
(b) distinguishing each component number and respective positions of all the component numbers in the figure section of the patent document;
(c) detecting a position of a cursor displayed in the figure section of the patent document on a display device; and
(d) searching for a component name of a component number from the component information list in response that the cursor is positioned within a preset region around the component number, and displaying the component name beside the component number in the figure section of the patent document on the display device.

6. The non-transitory storage medium as claimed in claim 5, wherein the step (a) comprises:
searching all of the component numbers mentioned in the description section, and recording positional information of each component number in the description section; and
extracting a component name for each component number according to the positional information of the component number in the description section, and creating the component information list.

7. The non-transitory storage medium as claimed in claim 5, wherein the step (b) comprises:
rotating a figure in the figure section by ninety degrees clockwise in response that the figure is displayed in a wrong orientation;
distinguishing each component number and a position of the component number in the figure section of the patent document; and
recording all of the distinguished component numbers and the respective positions of the component numbers in the figure section.

8. The non-transitory storage medium as claimed in claim 5, wherein the preset region around the component number is a rectangular area with a predetermined size, and the component number is in the middle of the rectangular area.

9. A computing device, the computing device comprising:
a storage unit;
at least one processor; and
one or more programs stored in the storage unit, executable by the at least one processor, the one or more programs comprising:
an extracting module operable to extract component numbers from a description section of a patent document that are coupled with a component name, and create a component information list based on the component numbers;
a distinguishing module operable to distinguish each component number and respective positions of all the component numbers in a figure section of the patent document;
a detection module operable to detect a position of a cursor displayed in the figure section of the patent document on a display device; and
a display module operable to search for a component name of a component number from the component information list in response that the cursor is positioned within a preset region around the component number, and display the component name beside the component number in the figure section of the patent document on the display device.

10. The computing device as claimed in claim 9, wherein the extracting module further operable to:
search all of the component numbers mentioned in the description section, and record positional information of each component number in the description section; and
extract a component name for each component number according to the positional information of the component number in the description section, and create the component information list.

11. The computing device as claimed in claim 9, wherein the distinguishing module further operable to:
rotate a figure in the figure section by ninety degrees clockwise in response that the figure is displayed in a wrong orientation;
distinguish each component number and a position of the component number in the figure section of the patent document; and
record all of the distinguished component numbers and the respective positions of the component numbers in the figure section.

12. The computing device as claimed in claim 9, wherein the preset region around the component number is a rectangular area with a predetermined size, and the component number is in the middle of the rectangular area.
